(19) United States
(12) Patent Application Publication
(10) Pub. No.: US 2011/0040405 A1
(43) Pub. Date: Feb. 17, 2011

(54) APPARATUS, METHOD AND COMPUTER-READABLE MEDIUM CONTROLLING WHOLE-BODY OPERATION OF HUMANOID ROBOT

(75) Inventors: Bok Man LIM, Seoul (KR); Kyung Shik Roh, Seongnam-si (KR); San Lim, Suwon-si (KR); Myung Hee Kim, Suwon-si (KR); Guo Chun Xu, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 12/852,175

(22) Filed: Aug. 6, 2010

(30) Foreign Application Priority Data
Aug. 12, 2009 (KR) 10-2009-74046

(51) Int. Cl. B25J 9/00

(52) U.S. Cl. 700/245

(57) ABSTRACT

Disclosed are an apparatus, a method and a computer-readable medium controlling whole-body operation of a humanoid robot. The humanoid robot recognizes a motion control code using binary data mapped according to a motion command represented by a language understood by a human to implement a whole-body operation. Since a control mode corresponding to a task space control and a control mode corresponding to a joint space control are used together to describe whole-body motion, the whole-body operation more similar to a human action may be easily implemented.

### CROSS-REFERENCE TO RELATED APPLICATIONS

This application claims the benefit of Korean Patent Application No. 2009-74046, filed on Aug. 12, 2009 in the Korean Intellectual Property Office, the disclosure of which is incorporated herein by reference.

### BACKGROUND

1. Field

Example embodiments relate to an apparatus, a method and a computer-readable medium controlling a whole-body operation of a humanoid robot by efficiently describing whole-body motion of the humanoid robot which acts like a human.

2. Description of the Related Art

An intelligent robot receives external information using a sense of sight or a sense of hearing, like a human, makes a judgment, and takes an appropriate action. A humanoid robot is a type of intelligent robot. The humanoid robot has the same appearance as a human, is bipedal, has two arms, and manipulates objects by hand.

The humanoid robot has joints similar to those of a human. Research into a humanoid robot providing various services in place of a person in a human working and living space has been actively conducted.

In order to allow a humanoid robot to smoothly perform a given service, a whole-body operation of the robot needs to be implemented like a human action. In other words, the humanoid robot needs to walk and freely move like a human. However, due to difficulty in controlling the kinetics of the robot, the operation of the robot is currently implemented in a limited range.

Examples of a control method applied to motion control of a robot include task space control and joint space control. The task space control is used to accurately control a robot's end effector, and the joint space control is used to generate a whole path according to a specific purpose when an initial posture and a final posture of the robot are given. In order to implement an operation of a robot like a human, the task space control and the joint space control having different control characteristics need to be used together. However, it is difficult to implement the operation of the robot having many joints due to complexity of multiple degrees of freedom thereof.

A control mode may be individually selected with respect to each of plural end effectors (head, trunk, arms and feet) of a robot to generate whole-body motion. That is, motion suitable for a purpose is performed in a selected control mode. When motion suitable for another purpose is necessary, a previous control mode of each of the end effectors of the robot is switched to a new control mode of each of the end effectors of the robot and the motion suitable for the purpose is performed.

In such a simple control mode switching method, if the whole-body motion of the robot is diversified, desired control modes need to be individually selected in many control modes to generate the whole-body motion. Thus, it is difficult to automate the generation of a variety of whole-body motions. In addition, this method is efficiently used to apply the task space control to the end effectors of the robot. However, this method has difficulty simultaneously dealing with the task space control and the joint space control. Accordingly, the robot does not judge suitable control modes, and a user needs to individually switch the control modes. Thus, the user is inconvenienced

### SUMMARY

Therefore, it is an aspect of the example embodiments to provide an apparatus, a method and a computer-readable medium related to whole-body motion of a humanoid robot and that the robot easily understands a motion command understood by a human when the robot implements a whole-body operation.

It is another aspect of the example embodiments to simultaneously deal with a task space control and a joint space control when a humanoid robot implements a whole-body operation.

The foregoing and/or other aspects are achieved by providing an apparatus controlling a whole-body operation of a humanoid robot, the apparatus including: an external controller to map a motion command described according to a motion scenario to data recognized by the robot and to provide the data; and a robot controller to control the whole-body operation of the robot according to whole-body motion generated using a control code recognized by the mapped data.

Communication modules to perform wired or wireless communication are respectively included in the external controller and the robot controller in order to transmit the mapped data.

The mapped data provided by the external controller may be binary data to recognize the control code.

The external controller may include a control mode setting unit to set control modes corresponding to the motion command, and a mapping unit to perform mapping to the binary data based on the setting result.

The control mode setting unit may include a plurality of switches which are independently operated, and any one or both of a control mode corresponding to a task space control and a control mode corresponding to a joint space control may be allocated to each of the plurality of switches.

The number of the plurality of switches may be increased or decreased according to a motion feature and a restriction condition.

The robot controller may include a code analysis unit to analyze a control code corresponding to the mapped data using a code table.

The foregoing and/or other aspects are achieved by providing an apparatus controlling a whole-body operation of a humanoid robot, the apparatus including: an external controller to set control modes to define a motion feature and a restriction condition according to a motion command describing whole-body motion of the humanoid robot and to binary data mapped according to the set control modes to the robot; and a robot controller to drive joints of the robot according to whole-body motion generated using a control algorithm suitable for a control code recognized by the binary data.

The foregoing and/or other aspects are achieved by providing a method of controlling a whole-body operation of a humanoid robot, the method including: mapping, by a processor, a motion command described according to a motion scenario to data recognized by the robot; providing the mapped data to the robot; and controlling, by the processor, the whole-body operation of the robot according to whole-body motion generated using a control code recognized by the mapped data.

The mapping of the data may be performed in the unit of segments corresponding to unit operations of the whole-body operation.

The mapping of the data may include setting control modes using a plurality of switches which are independently operated, setting bit values according to the set control modes, and obtaining binary data.

A group configured by control modes may be allocated to each of the plurality of switches, and the group may include any one or both of a control mode corresponding to a task space control and a control mode corresponding to a joint space control.

The foregoing and/or other aspects are achieved by providing a method of controlling a whole-body operation of a humanoid robot the method including: converting, by a processor, a motion command represented by a language used by a human into a control code understood by the robot; generating, by the processor, whole-body motion using a control algorithm suitable for the converted control code; and driving, by the processor, joints of the robot according to the generated whole-body motion and controlling the whole-body operation.

Since a motion command represented by a language understood by a human is converted to be understood by a robot and is provided to the robot, the searching and classification of a control mode are facilitated. In addition, since a task space control and a joint space control may be used together, a whole-body operation more similar to a human action may be implemented. Since a new whole-body operation is added and a new control mode is added to the robot when improving a robot's function, it may be possible to rapidly and appropriately cope with the development of a new product.

The foregoing and/or other aspects are achieved by providing at least one computer readable medium including computer readable instructions that control at least one processor to implement methods of one or more embodiments.

Additional aspects and/or advantages will be set forth in part in the description which follows and, in part, will be apparent from the description, or may be learned by practice of the description.

### BRIEF DESCRIPTION OF THE DRAWINGS

These and/or other aspects will become apparent and more readily appreciated from the following description of the embodiments, taken in conjunction with the accompanying drawings of which:

FIG. 1 is a view showing the appearance of a humanoid robot according to example embodiments;

FIGS. 2A to 2D are views showing whole-body operations of a humanoid robot, which are variously implemented, according to example embodiments;

FIG. 3 is a block diagram showing an apparatus for controlling a whole-body operation of a humanoid robot according to example embodiments;

FIG. 4 is a view showing an operation to set control modes using a plurality of switches according to example embodiments;

FIG. 5 is a view explaining correspondence between control modes set according to motion commands and control codes when a humanoid robot kicks a ball, according to example embodiments; and

FIG. 6 is a flowchart illustrating a method of controlling a whole-body operation of a humanoid robot according to example embodiments.

### DETAILED DESCRIPTION

Reference will now be made in detail to the embodiments, examples of which are illustrated in the accompanying drawings, wherein like reference numerals refer to like elements throughout.

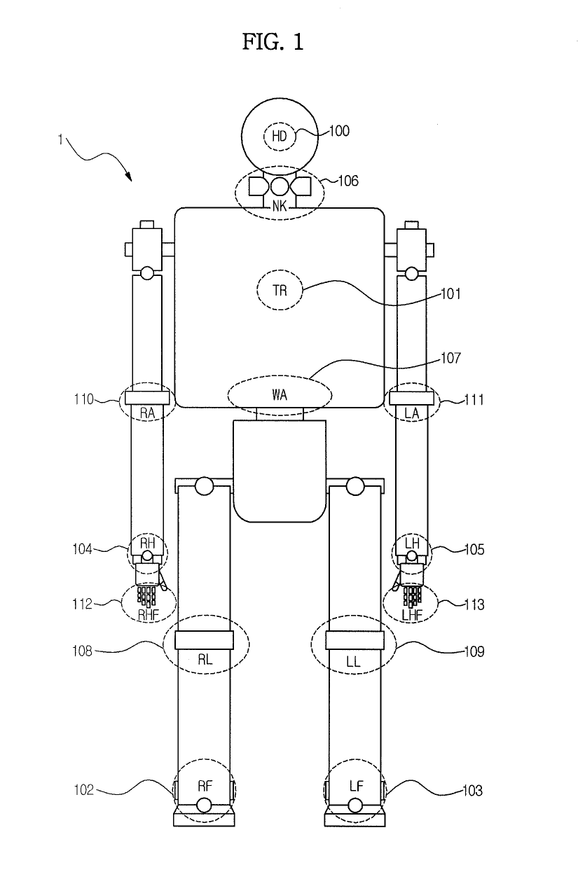

As shown in FIG. 1, a humanoid robot 1 has an appearance similar to that of a human. The humanoid robot 1 includes joints which are subjected to task space control and joints which are subjected to joint space control.

The joints which are subjected to the task space control include a head joint HD, (100) a trunk joint TR, (101) a right foot joint RF, (102) a left foot joint LF, (103) a right hand joint RH, (104) and a left hand joint LH (105). The joints which are subjected to the joint space control include a neck joint NK (106), a waist joint WA (107), a right leg joint RL (108), a left leg joint LL (109), a right arm joint RA (110), a left arm joint LA (111), a right finger joint RHF (112), and a left finger joint LHF (113).

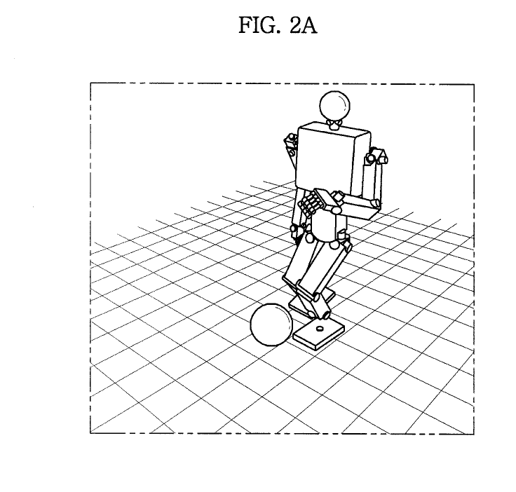

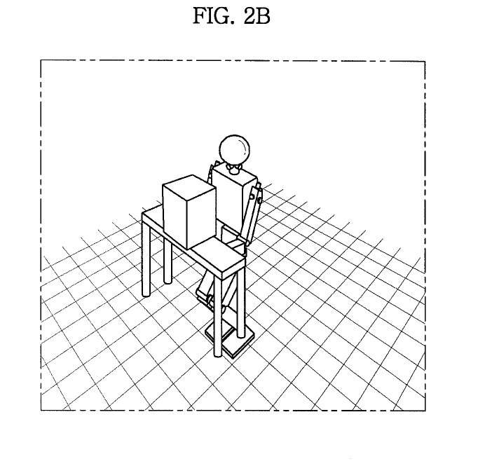

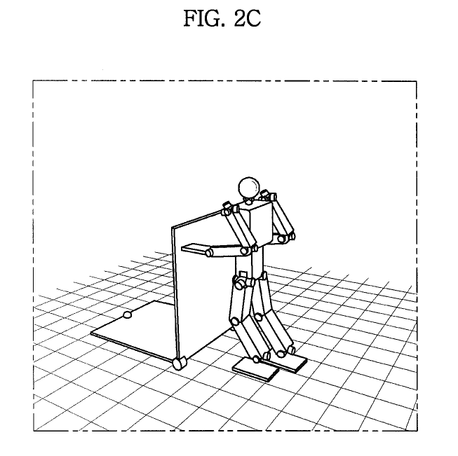

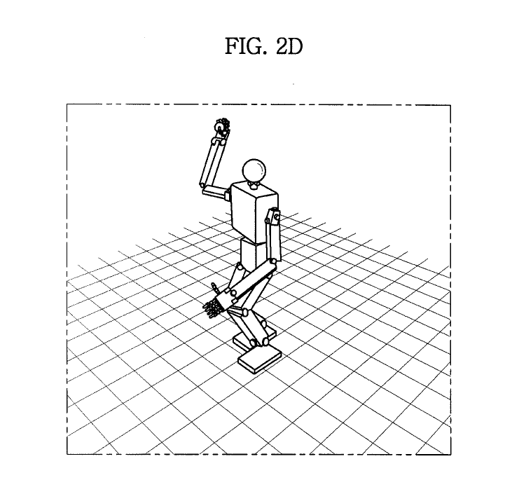

The humanoid robot 1 may implement various whole-body operations. For example, an operation to kick a ball is shown in FIG. 2A, an operation to hold up a table on which an object is placed is shown in FIG. 2B, an operation to push a cart is shown in FIG. 2C, and an operation to throw a ball is shown in FIG. 2D.

As shown in FIG. 2A, if the robot performs the operation to kick the ball, the task space control and the joint space control are simultaneously applied. The task space control to accurately kick the ball is applied to the right foot, but an accurate control may not be applied to the upper part of the body and the two arms of the robot. At this time, the robot needs to keep a stable posture to not fall, as a necessary restriction condition. Accordingly, the task space control is performed with respect to the foot used to kick the ball, and, at the same time, the joint space control is performed with respect to the shaken arms when kicking the ball.

Since the task space control and the joint space control are simultaneously performed in order to perform a whole-body operation to accomplish a purpose, control modes corresponding thereto need to be set. Even when a control algorithm to perform many motion plans and motion controls in correspondence with various whole-body operations is included in the robot, it is difficult to implement a motion plan and motion control suitable for a desired whole-body operation if the robot does not understand the setting of control modes. Therefore, the setting of the control modes needs to be provided to and understood by the robot.

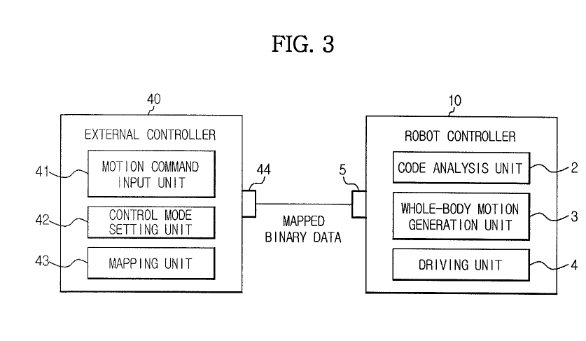

FIG. 3 is a block diagram of an apparatus controlling a whole-body operation of a humanoid robot according to example embodiments.

An external controller 40 serves to deliver a control command to request a whole-body operation, which is prepared in advance according to the intention of a user, from outside of the robot.

The external controller 40 receives a motion command defining the whole-body operation of the robot, converts the motion command into data understood by the robot, and provides the data to a robot controller 10. To this end, communication modules 5 and 44 to perform wired or wireless communication are included in the robot controller 10 and the external controller 40, respectively.

A motion command input unit 41 provides a motion command input by the user to a control mode setting unit 42.

The motion command is represented by a language understood by humans. The motion command is described in a state of dividing the whole-body operation in the unit of unit operations from beginning to end. Each of the unit operations is one motion segment and a set of motion segments configures a motion scenario.

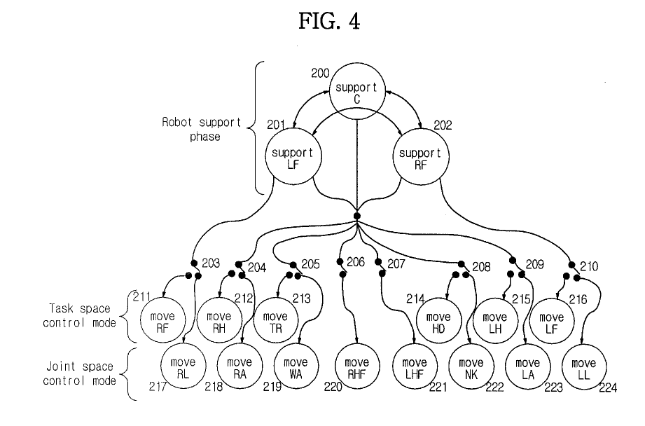

The control mode setting unit 42 arranges and sets control modes in the unit of segments in consideration of the priority of a motion feature and a restriction condition of the motion command. At this time, as shown in FIG. 4, the control mode setting unit 42 sets the control modes using a plurality of switches 203-210. Although eight switches are used in the present embodiment, the example embodiments are not limited thereto, and the number of switches may be increased or decreased according to the motion feature and the restriction condition.

The plurality of switches 203-210 are independently operated and correspond to robot support phases 200, 201 and 202. The support phases may be mutually switched. The first support phase 200 indicates that the robot is supported by the center of the robot, the second support phase 201 indicates that the robot is supported by the left foot of the robot, and the third support phase 202 indicates that the robot is supported by the right foot of the robot.

One end of the first switch 203 is connected to the second support phase 201, one end of the eighth switch 210 is connected to the third support state 202, and one end of the second to seventh switches 204-209 is commonly connected to the first to third support phases 200, 201 and 202.

The first to third switches 203-205 and the sixth to eighth switches 208-210 are allocated to any one or both of a control mode corresponding to the task space control and a control mode corresponding to the joint space control so as to correspond to groups and are selectively connected to any one of the control modes belonging to their groups. In each group, control modes having exclusive characteristics in performing the whole-body operation of the robot are preferably configured. That is, control modes are configured which are difficult to simultaneously perform when performing the whole-body operation.

The first switch 203 is connected to any one of a control mode 211 to move the right foot joint 102 and a control mode 217 to move the right leg joint 108. The second switch 204 is connected to any one of a control mode 212 to move the right hand joint 104 and a control mode 218 to move the right arm joint 110. The third switch 205 is connected to any one of a control mode 213 to move a trunk joint 101 and a control mode 219 to move the waist joint 107. The sixth switch 208 is connected to any one of a control mode 217 to move the head joint 100 and a control mode 222 to move the neck joint 106. The seventh switch 209 is connected to any one of a control mode 215 to move the left hand joint 105 and a control mode 223 to move the left arm joint 111. The eighth switch 210 is connected to any one of a control mode 216 to move the left foot joint 103 and a control mode 224 to move the left leg joint 109.

The fourth switch 206 and the fifth switch 207 are selectively connected to a single control mode corresponding to the joint space control. The fourth switch 206 may be connected to a control mode 220 to move the right finger joint 112 and the fifth switch 207 may be connected to a control mode 221 to move the left finger joint 113.

The control mode setting unit 42 selectively connects the plurality of switches 203-210 in correspondence with the motion command to set the control modes. The control modes belonging to the task space control and the joint space control may be used together according to the setting state. The setting result is provided to a mapping unit 43.

The mapping unit 43 performs mapping to 0 and 1 according to the selective operations of the plurality of switches 203-210 to obtain binary data. The binary data is obtained according to the operations of the switches. Since the bit values of the binary data are different from each other, values obtained by converting the binary data into decimal digits are different from each other. Accordingly, the binary data is used to analyze a motion control code corresponding to a set control mode by the robot controller 10.

The mapped binary data is provided to the robot controller 10 through the communication module 44.

A code analysis unit 2 includes a code table which is prepared using indexes in advance, and analyzes a motion control code by converting the binary data received through the communication module 5 into a decimal digit and searching the code table using the decimal digit. The analyzed motion control code is provided to a whole-body motion generation unit 3. The whole-body motion generation unit 3 recognizes control modes corresponding to the analyzed motion control code and generates whole-body motion according to the recognized control modes. At this time, since the whole-body operations are stored in a database, the whole-body motion generation unit 3 may search for and reprocess motion data requested by the control modes to generate reference motion to accomplish a goal. Then, the whole-body motion generation unit 3 calculates the control input values of the joints to change the whole-body motion according to a desired whole-body operation using a control algorithm established based on the reference motion.

A driving unit 4 controls a desired whole-body operation by inputting the control input values calculated in correspondence with the generated whole-body motion to the joint motors respectively provided in the joints and driving the joints of the robot.

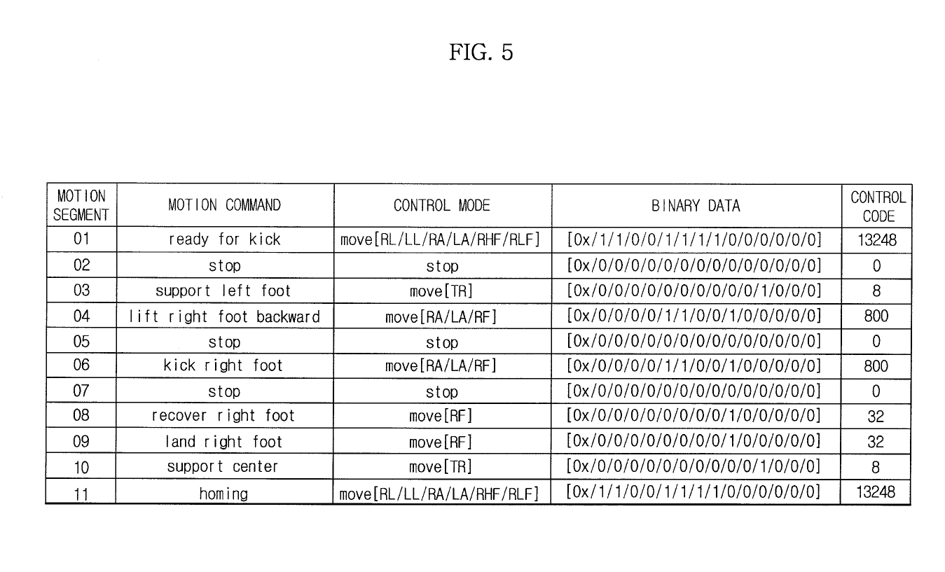

FIG. 5 is a view explaining correspondence between control modes set according to motion commands and control codes when a humanoid robot kicks a ball, according to example embodiments.

The whole-body operation to kick the ball using the right foot is described according to a motion scenario using motion commands. The motion scenario includes first to eleventh segments 01 to 11 to describe the operation to kick the ball using the motion commands in the unit operations. Since the right foot needs to be subjected to an end effector control to accurately kick the ball, but the upper part of the body and the arms may not be subjected to accurate end effector control, the task space control is performed with respect to foot motion and the joint space control is performed with respect to the arm motion. At this time, the robot needs to keep a stable posture to not fall, as a necessary restriction condition. Accordingly, the motion command described in each segment includes a portion having a motion plan. In addition, the switches 203-210 are selectively operated in correspondence with the portion having the motion plan to set the control modes.

For example, the motion command of the fourth motion segment 04 will be examined. The control modes corresponding to the motion command “lift right foot backward” are “move [RA/LA/RF]”. This indicates that the joint space control is performed with respect to the right arm RA 110 and the left arm LA 111 and the task space control is performed with respect to the right foot RF 102. That is, the foot is subjected to an accurate control and arms are subjected to less accurate control. In motion segments (01, 11), (3, 10), (04, 06) and (08, 09), a control may be performed using the same control modes.

According to a method of describing whole-body motion, the whole-body motion may be automated by easily searching for and reprocessing desired motion when whole-body motion is diversified and various whole-body operations are implemented.

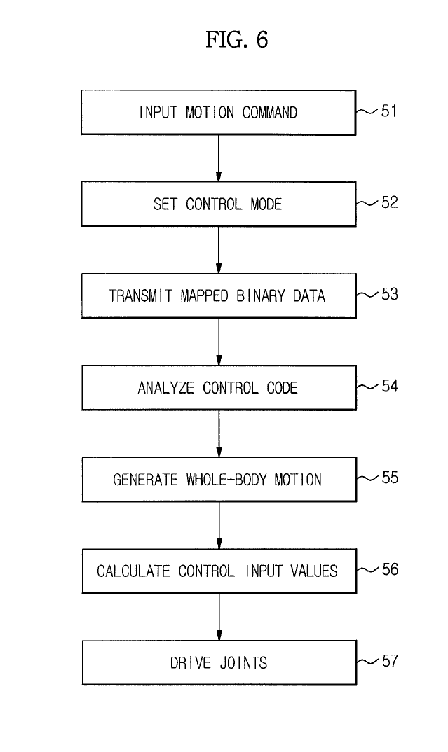

FIG. 6 is a flowchart illustrating a method of controlling a whole-body operation of a humanoid robot according to example embodiments.

The user inputs a motion command represented by a language understood by a human through the motion command input unit 41 of the external controller 40 to describe whole-body motion to accomplish a goal (51).

The control mode setting unit 42 sets the control modes using the plurality of switches 203-210 in correspondence with the input motion command. The motion command is described in the unit of segments. In the setting of control modes, the control mode corresponding to the task space control and the control mode corresponding to the joint space control may be used together. The mapping unit 43 maps the selective operations of the switches to any one of two bit values 0 and 1 based on the setting of the control modes to obtain binary data. The mapped binary data is transmitted to the robot controller 10 through the communication module 44 (53).

The code analysis unit 2 which receives the binary data through the communication module 5 of the robot controller 10 searches the code table which is prepared in advance, and analyzes a motion control code corresponding to the binary data (54). Then, the whole-body motion generation unit 3 recognizes the control modes corresponding to the analyzed motion control code, searches for and reprocesses motion data requested according to the recognized control modes, generates the reference motion to accomplish a purpose (55), and calculates the control input values of the joints to change whole-body motion according to a desired whole-body operation using the control algorithm established based on the reference motion (56). The control input values are provided to the joint motors respectively provided in the joints to drive the joints of the robot and implement a desired whole-body operation (57).

As described above, the robot is allowed to recognize the motion control code using binary data obtained by a mapping operation and the robot understands the motion command described according to the motion scenario. The intervention of the user is minimized and the searching and classification of motion data to implement various whole-body operations by the robot are facilitated. Thus, the control of the operation of the robot may be automated. Since the control mode corresponding to the task space control and the control mode corresponding to the joint space control may be used together, a whole-body operation more similar to a human action may be implemented.

The above-described embodiments may be recorded in computer-readable media including program instructions to implement various operations embodied by a computer. The media may also include, alone or in combination with the program instructions, data files, data structures, and the like. Examples of computer-readable media (computer-readable storage devices) include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. The computer-readable media may be a plurality of computer-readable storage devices in a distributed network, so that the program instructions are stored in the plurality of computer-readable storage devices and executed in a distributed fashion. The program instructions may be executed by one or more processors or processing devices. The computer-readable media may also be embodied in at least one application specific integrated circuit (ASIC) or Field Programmable Gate Array (FPGA). Examples of program instructions include both machine code, such as produced by a compiler, and files containing higher level code that may be executed by the computer using an interpreter. The described hardware devices may be configured to act as one or more software modules in order to perform the operations of the above-described exemplary embodiments, or vice versa.

Although example embodiments have been shown and described, it should be appreciated by those skilled in the art that changes may be made in these embodiments without departing from the principles and spirit of the disclosure, the scope of which is defined in the claims and their equivalents.

What is claimed is:

1. An apparatus controlling a whole-body operation of a humanoid robot, the apparatus comprising:
an external controller to map a motion command described according to a motion scenario to data recognized by the robot and to provide the data; and
a robot controller to control the whole-body operation of the robot according to whole-body motion generated using a control code recognized by the mapped data.

2. The apparatus according to claim 1, wherein communication modules to perform wired or wireless communication are respectively included in the external controller and the robot controller in order to transmit the mapped data.

3. The apparatus according to claim 1, wherein the mapped data provided by the external controller is binary data to recognize the control code.

4. The apparatus according to claim 3, wherein the external controller includes a control mode setting unit to set control modes corresponding to the motion command, and a mapping unit to perform mapping to the binary data based on the setting result.

5. The apparatus according to claim 4, wherein:
the control mode setting unit includes a plurality of switches which are independently operated, and
any one or both of a control mode corresponding to a task space control and a control mode corresponding to a joint space control is allocated to each of the plurality of switches.

6. The apparatus according to claim 5, wherein the number of the plurality of switches is increased or decreased according to a motion feature and a restriction condition.

7. The apparatus according to claim 1, wherein the robot controller includes a code analysis unit to analyze a control code corresponding to the mapped data using a code table.

8. An apparatus controlling a whole-body operation of a humanoid robot, the apparatus comprising:
an external controller to set control modes to define a motion feature and a restriction condition according to a motion command describing whole-body motion of the humanoid robot and to binary data mapped according to the set control modes to the robot; and
a robot controller to drive joints of the robot according to whole-body motion generated using a control algorithm suitable for a control code recognized by the binary data.

9. A method of controlling a whole-body operation of a humanoid robot, the method comprising:
mapping, by a processor, a motion command described according to a motion scenario to data recognized by the robot;
providing the mapped data to the robot; and
controlling, by the processor, the whole-body operation of the robot according to whole-body motion generated using a control code recognized by the mapped data.

10. The method according to claim 9, wherein the mapping of the data is performed in the unit of segments corresponding to unit operations of the whole-body operation.

11. The method according to claim 9, wherein the mapping of the data includes setting control modes using a plurality of switches which are independently operated, setting bit values according to the set control modes, and obtaining binary data.

12. The method according to claim 11, wherein:
a group configured by control modes is allocated to each of the plurality of switches, and
the group includes any one or both of a control mode corresponding to a task space control and a control mode corresponding to a joint space control.

13. A method of controlling a whole-body operation of a humanoid robot, the method comprising:
converting, by a processor, a motion command represented by a language used by a human into a control code understood by the robot;
generating, by the processor, whole-body motion using a control algorithm suitable for the converted control code; and
driving, by the processor, joints of the robot according to the generated whole-body motion and controlling the whole-body operation.

14. At least one computer readable medium comprising computer readable instructions that control at least one processor to implement the method of claim 9.

15. At least one computer readable medium comprising computer readable instructions that control at least one processor to implement the method of claim 10.

16. At least one computer readable medium comprising computer readable instructions that control at least one processor to implement the method of claim 11.

17. At least one computer readable medium comprising computer readable instructions that control at least one processor to implement the method of claim 12.
